(19) United States
(12) Patent Application Publication
(10) Pub. No.: US 2016/0371439 A1
(43) Pub. Date: Dec. 22, 2016

(54) PATIENT MATCHING SYSTEM

(71) Applicant: Pager, Inc., New York, NY (US)

(72) Inventors: Oscar Salazar, New York, NY (US); Gaspard De Dreuzy, New York, NY (US); Philip Eytan, New York, NY (US); Cordell Ratzlaff, Palo Alto, CA (US)

(21) Appl. No.: 15/190,025

(22) Filed: Jun. 22, 2016

Related U.S. Application Data
(60) Provisional application No. 62/183,070, filed on Jun. 22, 2015.

(51) Int. Cl. G06F 19/00; G06F 17/30

(52) U.S. Cl. CPC G06F 19/322; G06F 19/328; G06F 19/3418; G06F 17/3053; G06F 17/30867

(57) ABSTRACT

A patient matching system receives a match request from a patient device, indicating that the patient desires to be matched with a provider of medical services. The patient matching system determines one or more matching providers based on patient information and provider information. The patient matching system may rank the matching providers based on the strength of the match. The patient matching system may request confirmation by a matched provider, and upon confirmation, the patient matching system may send a match notification to the requesting patient.

### CROSS-REFERENCE TO RELATED APPLICATIONS

This application claims the benefit of and priority to U.S. Provisional Application No. 62/183,070 filed Jun. 22, 2015, the entire contents of which are incorporated herein by reference.

### BACKGROUND

This invention relates generally to coordinating medical care for a patient, and particularly to matching patients and medical providers.

In traditional models for medical care, a patient travels to a medical clinic, office, or hospital for medical services. In many cases, appointments are required to be made weeks or months in advance to avoid long waits for walk-in care. However, in many cases, it is not feasible to make appointments in advance. For instance, a medical condition may arise that requires immediate or near-immediate assistance from a medical professional. Further, traveling to medical clinics can be costly, time-consuming, and inconvenient for patients. Some doctors avoid these inconveniences by traveling to a patient's location to provide care, termed a house call, but finding a doctor that makes house calls can be very difficult, and patients may be unable to find such a doctor on short notice. Additionally, a patient may be unable to effectively choose a doctor for the house call and schedule the doctor's visit. In addition, determining insurance coverage and ensuring patient notes are recorded for a house call is difficult to do while maintaining freedom to select a doctor to visit the patient.

### BRIEF DESCRIPTION OF THE DRAWINGS

FIG. 1 illustrates a computing environment for matching a patient with a medical provider, according to one embodiment.

FIG. 2 illustrates an example patient matching scenario, according to one embodiment.

FIG. 3 illustrates a patient matching system, according to one embodiment.

FIG. 4 is an example process for matching a patient with a provider, according to one embodiment.

The Figures (FIGS.) and the following description relate to example embodiments by way of illustration only. It should be noted that from the following discussion, alternative embodiments of the structures and methods disclosed herein will be readily recognized as viable alternatives that may be employed without departing from the principles of what is claimed.

### DETAILED DESCRIPTION

I. Configuration Overview

A patient matching system selects and ranks providers for a patient to provide on-demand medical care to a patient's physical location. To schedule an appointment for medical care, the patient matching system determines eligible providers for a patient and ranks the providers, after which a provider is selected for the medical care from the ranked providers. To schedule appointments, the patient matching system receives patient information and provider information, and determines a match between a patient and a provider when a match request is received. Patient information may include the patient's location, the patient's schedule, the patient's desired medical services, the patient's age, the patient's medical insurance details, and the patient's desired price for services. Provider information may include the provider's location, the provider's schedule, the provider's offered medical services, the provider's accepted insurance, and the provider's price for services. Patients and providers use computing devices to communicate with a patient matching system via a network.

II. Computing Environment

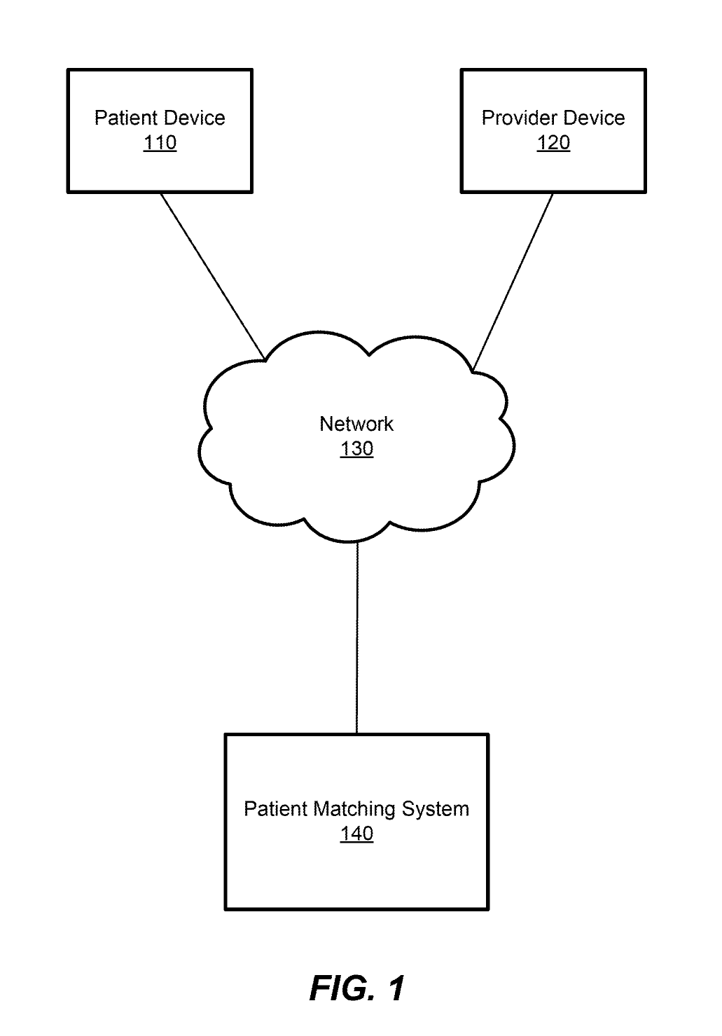

FIG. 1 illustrates a computing environment for matching a patient with a medical provider based on characteristics of the patient and the medical provider, according to one embodiment. The environment includes a patient device 110, a provider device 120, a network 130, and a patient matching system 140.

The network 130 may comprise any combination of local area and/or wide area networks, the internet, or one or more intranets, using both wired and wireless communication systems to provide a communication channel between the various components.

Patient matching system 140 receives and stores data, including requests and messages, sent by patient devices 110 and provider devices 120 relating to receiving and providing medical services. Patient matching system 140 receives a match request from a patient and matches the patient with one or more providers responsive to receiving the match request. In one embodiment, patient matching system 140 scores and ranks matching providers to determine a provider to service the match request. Patient matching system 140 may send match notifications or confirmation requests to patient devices 110 and provider devices 120.

Patients use patient devices 110 to access the patient matching system 140 and send a match request to the matching system 140. The match request includes patient information for the patient matching system to determine a match between the patient and a provider. The patient device 110 also receives and displays information associated with the match to the patient. A patient device 110 is a computing device including a processor, a memory, a display, an input device, and a network device for communicating with the patient matching system 140. For example, the patient device 110 may be a desktop computer, a laptop computer, a tablet computer, a smart phone, or any other device including computing functionality and data communication capabilities. The patient device 110 may also include a location device (e.g., a GPS receiver, cellular antenna, etc.) that may capture and provide location information of the device.

In various embodiments, patients use various input methods to provide information to patient devices 110 and exchange data with the patient matching system 140. In one embodiment, the processor of the patient device 110 operates computer software configured to access the patient matching system 140 by sending and receiving data associated with finding a provider. The software may be designed to work specifically with the patient matching system 140 or may be a general application for accessing content, such as a web browser. In another embodiment, data may be sent and received using a messaging application via particular messaging interfaces, such as a Short Messaging Service (SMS) interface, an instant messaging interface, or an email-based interface.

Depending on the characteristics and capabilities of the input method for a patient in a given embodiment, a user interface or other prompts are provided by the patient device 110 to receive data required by the patient matching system 140. For example a graphical user interface may prompt users for required data and receive user inputs via a dedicated interface. In one embodiment, the patient device 110 includes a microphone and a voice command interface which receives and interprets audible user inputs. The user interface may also be presented by another application. For example, if the input method is a SMS interface, SMS messages from the patient matching system 140 may prompt users for required data, and users may send data to the patient matching system 140 by replying with SMS messages. If capable, the input method may also retrieve certain data directly from an operating system or other applications of the patient device 110 without specific user input (e.g., schedule data from a calendar application, location data, etc.). Data may be stored (e.g., locally on the patient device 110 or remotely on the patient matching system 140) for later retrieval and use, such that certain stored data is not retrieved each time the system is used.

Patient information is information associated with a patient that is relevant to finding a matching provider. Examples of patient information include the patient's location, the patient's schedule, the patient's medical condition, the patient's desired medical services, the patient's age, the patient's insurance, and the patient's desired price for medical services. Patient information may be sent with a match request to the patient matching system 140, while other patient information may be stored on the patient matching system 140. For example, patient information that changes less frequently (e.g., insurance, price preferences, etc.) may be stored on the patient matching system 140 and retrieved when a match request is received. Patient information that changes more frequently or is request-specific (e.g., location, schedule, desired medical services, etc.) may be sent by the patient device 110 as part of the match request. Patient information sent with the match request may be received by patient input (e.g. via a user interface), or it may be retrieved from the patient device 110 (e.g. from storage or from an application) without specific patient input.

The patient location is used by the patient matching system to determine a matching provider near the requesting patient. A patient location may be automatically determined by the location device on the patient device 110 or provided by the patient to the patient device 110 (e.g., as an address, geographic coordinates, etc.). In one embodiment, a patient provides one or more default locations (e.g. a home location, a work location, etc.) and the location device of the patient device 110 determines the actual location of the patient device at the time of a match request. The patient matching system 140 determines whether the patient location is at one of the default locations, for example, by computing the proximity of the device-determined location to each of the default locations. If the computed proximity for a particular default location is below a threshold (e.g., 500 feet), the patient location is considered to be at this default location.

Patient schedule information is used to determine when a patient is available to receive medical care. The patient schedule information may be in the form of a calendar, in which the patient is either available or unavailable during various time ranges. Calendar entries may include both appointments scheduled by the patient matching system 140 as well as events not related to the patient matching system. Calendar entries may be received from various applications of the patient device 110. For example, the software configured to access the patient matching system 140 may retrieve appointments and other schedule information from a calendar application of the patient device 110. Medical insurance information may include the patient's medical insurance provider or plan details. Patient information may include deductibles and covered services. Medical insurance information may be used to determine which providers accept a patient's insurance or to more accurately determine price information for matching purposes.

The patient's medical condition may include past and present medical conditions (illness, injury, etc.), and may include acute or chronic conditions. The patient's medical condition may further include symptoms or signs reported by the patient.

Price preferences may include how much a patient is willing to pay for medical services. Price preferences may be associated with a specific request or service. For example, the price preference may relate to the specific services requested in the match request. Price preferences may be expressed as a range (e.g., $200-$400) or a maximum value (e.g., less than $400).

Patient information may include additional preference information such as the patient's age. Patient information may further include a patient's preferences for a provider's gender, age, specialty, or experience. Patients may be matched with providers based on price and other preference information. In one embodiment, a provider's age is not used for matching and is not exposed to patients.

Provider devices 120 can be the same type of devices as the devices 110. Providers use provider devices 120 to access the patient matching system 140 to send provider information for determining a matching patient and to receive information associated with matches.

Provider information is information associated with a provider that is relevant to matching the provider with a patient. Examples of provider information are the provider's location, the provider's schedule, the provider's offered medical services, the provider's accepted insurance, and the provider's prices for services. In various embodiments, provider information is maintained by the patient matching system 140 or sent by the provider device 120. For example, provider information that changes less frequently (e.g., offered medical services, insurance, and price information) may be stored on the patient matching system 140 and retrieved for matching when a match request is received. Provider information that changes more frequently (e.g., location, schedule, etc.) may be sent by the provider device 120 upon notification by the patient matching system 140 that a match request has been received. Provider information sent by the provider device 120 may be received by the provider device by patient input (e.g. via a user interface), or it may be retrieved from the provider device (e.g. from storage or from an application) without specific provider input.

The provider location is used by the patient matching system to determine a distance between the provider and the requesting patient. The provider location may be automatically determined by a location device on the provider device 120 or provided by the provider as an input to the provider device (e.g., as an address, geographic coordinates, etc.). In one embodiment, a provider provides one or more default locations and the location device of the provider device 120 determines the actual location of the provider device at the time of a match request. The patient matching system 140 determines whether the provider location is one of the default locations, for example, by computing the proximity of the device-determined location to each of the default locations. If the computed proximity for a particular default location is below a threshold (e.g., 500 feet), the provider location is considered to be the default location.

Provider schedule information is used to determine when a provider is available to provide medical care. The provider schedule information may be in the form of a calendar, in which the provider is either available or unavailable during various time ranges. Calendar entries may be received from various applications of the provider device 120. For example, the software configured to access the patient matching system 140 may retrieve appointments and other schedule information from a calendar application of the provider device 120. The provider schedule information may also include other appointments scheduled for the provider by the patient matching system 140. The location of an appointment scheduled by the patient matching system 140 may be treated as the location of the provider for availability after the scheduled appointment.

Provider information may include the provider's medical specialty area or otherwise indicate the medical services the provider offers. For example, if a provider specializes in knee injuries, provider information may include a set of services that providers specializing in knee injuries offer. In one embodiment, the set of services is a standard list that may be selected by the provider. In another embodiment, the provider specifically indicates each service that is offered. A particular match request may include the medical services desired by the requesting patient. This information, along with information regarding offered medical services may be used to determine a matching provider for the patient.

Provider medical insurance information may include which medical insurance plans and insurance providers the provider accepts. As a result, a patient may be matched with a provider that accepts the patient's insurance. Provider price information may include estimates for medical services, copay information, and other price data.

III. Example Matching Scenario

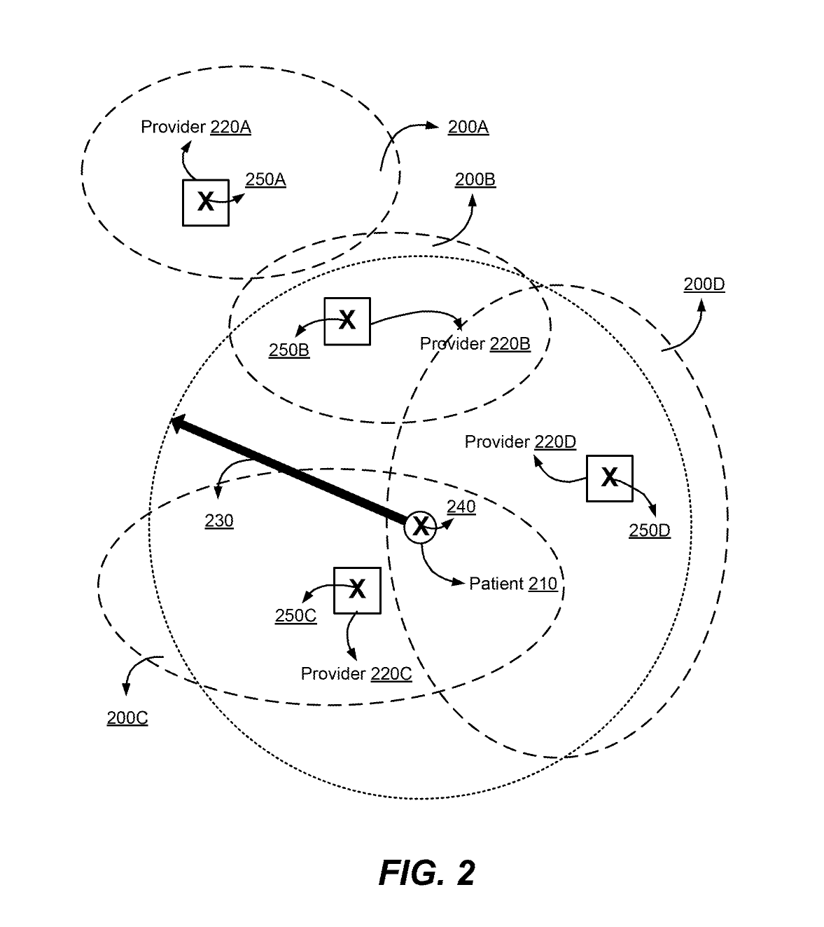

FIG. 2 illustrates an example patient matching scenario, according to one embodiment. In this example scenario, a patient 210 sends a match request via a patient device 110. The patient matching system 140 receives the match request and matches the patient with one of the providers 220 based on patient information and provider information. The patient matching system 140 uses the locations of providers and patients to determine which provider to select for a matching request.

In the example of FIG. 2, the patient 210 has an associated patient location 240. The patient 210 has an associated patient matching distance 230. The patient matching distance 230 indicates the maximum distance at which a provider may be selected for the patient. The patient matching distance 230 may have a default value chosen by an implementer (e.g., an administrator of the patient matching system). The patient matching distance 230 may also be set by the patient 210 or determined based on preferences of the patient. While shown here as a distance, the patient matching distance may also be determined based on a maximum amount of time the patient is willing to wait for an appointment, from which the patient matching system 140 may determine the patient matching distance 230 that permits a provider to travel and arrive at the patient's location within the maximum amount of time. The patient matching distance 240 may be determined from the maximum amount of time using traffic conditions, transportation options, bus schedules, and so forth to estimate the locations from which a provider can arrive and generate the patient matching distance 240.

Each provider 220 has an associated provider location 250. Each provider 220 has an associated coverage area 200. A coverage area 200 is a geographical area where medical services are offered by a provider or group of providers. For example, a coverage area 200 may be defined by a provider's medical license (e.g., to practice in one state but not another), or by city, zip code, or other geographical area that a provider is willing to travel to and provide coverage. The coverage area may also be limited based on the provider's location and a distance from the provider. Alternatively, the coverage area may be determined by a maximum distance from a designated location, such as a provider's home office location. A coverage area 200 may also be an area that changes based on the provider location of one or more providers (e.g., an area within a certain distance of a provider, an area within a certain travel time of a provider, etc.). One provider may be associated multiple coverage areas. Likewise, a coverage area may be associated with multiple providers. Accordingly, a patient may fall within multiple coverage areas associated with different providers.

In one embodiment, the patient is matched with providers within the patient matching distance of the patient's location. In the example of FIG. 2, providers 220B, 220C, and 220D are located within the patient matching distance 230 of the patient location 240. Provider 220A is located outside the patient matching distance. Thus, patient 210 would not be matched with provider 220A.

In another embodiment, the patient is matched with providers whose coverage area 200 includes patient location 240. In the example of FIG. 2, the patient location 240 is within the coverage area 200C of provider 220C and the coverage area 200D of provider 220D. The patient location 240 is not within the coverage area 200A of provider 220A or the coverage area 200B of provider 220B. Thus, patient 210 would not be matched with provider 220A or 220B.

In various embodiments, determining whether a provider is within the patient matching distance 230 and whether the patient is within a provider coverage area 200 does not preclude a match, but is instead used as a factor in determining whether provider information is sufficiently compatible with patient information to match the patient with the provider.

IV. Patient Matching System

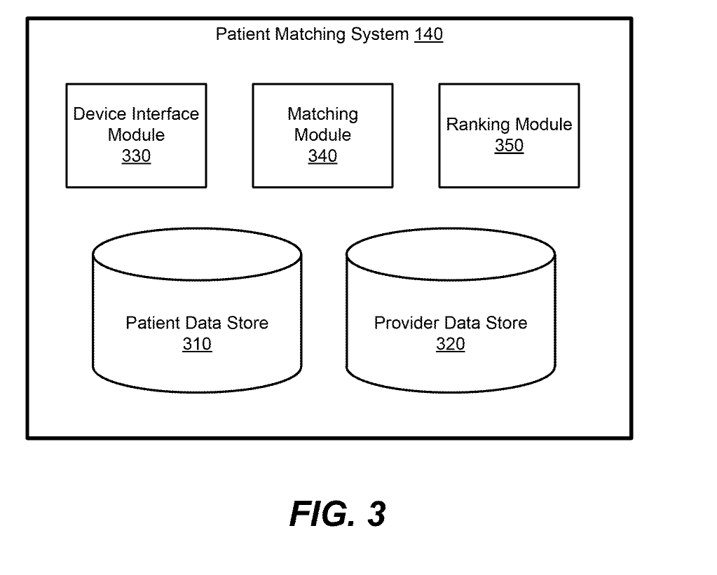

FIG. 3 illustrates a patient matching system, according to one embodiment. Patient matching system 140 includes a device interface module 330, a matching module 340, a ranking module 350, a patient data store 310, and a provider data store 320.

A patient data store 310 and a provider data store 320 store and maintain data used by the patient matching system 140. The patient data store 310 stores patient information. The provider data store 320 stores provider information. Depending upon the embodiment, the data stores 310, 320 may include one or more types of non-transitory computer-readable persistent storage media.

The device interface module 330 receives data from patient devices 110 and provider devices 120. The device interface module 330 may provide a variety of interfaces for interacting with a number of different types of devices. For example, when a device 110 accesses the patient matching system 140 via a web browser, the device interface module 330 provides access via a web interface. Similarly, when a device accesses the patient matching system 140 via an application programming interface (API), the device interface module 330 responds via the API. When a device uses a messaging system (e.g., SMS or an instant messenger) to communicate with the patient matching system 140, the device interface module 330 provides access via a messaging system.

In various embodiments, the device interface module 330 receives data via network 130. Received data may comprise patient information, provider information, match requests, responses to confirmation requests, etc. Data received by the device interface module 330 may be stored in the provider data store 320 or the patient data store 310. For example, patient information is stored in the patient data store 310 and provider information is stored in the provider data store 320. The device interface module 330 may also send data to devices via the network 130 to interrogate devices regarding information or provide confirmation other notifications to devices. Such sent data may comprise patient information, provider information, match notifications, or confirmation requests.

The device interface module 330 is further configured to communicate with the other modules of the patient matching system 140. The modules carry out any functions requested by a device and return the appropriate response to the device interface module 330 for sending to the device.

The matching module 340 determines one or more matching providers for a matching request based on patient information and provider information. The matching module 340 may receive provider or patient information from the device interface module 330, or it may retrieve patient or provider information from the patient data store 310 or provider data store 320. The matching module 340 matches providers to the requesting patient by determining whether a provider's provider information is compatible with the requesting patient's patient information (e.g., the distance between locations of provider and patient is below a determined threshold, the provider offers medical services desired by patient, the provider is available when patient is available, the provider accepts patient's insurance, location preferences, gender preferences, service costs, other patient preferences, etc.). In one embodiment, the matching module 340 determines a patient's medical needs and acuity from patient information. The matching module 340 determines other user patient preferences such as cost preferences, location preferences, gender preferences, etc. The matching module 340 matches patients with one or more providers who can meet the patient's medical needs and best fit the patient's preferences.

In various embodiments, a match may be identified even when not all provider information is compatible with patient information for the match request. For example, a provider may be returned as a match even if the provider's price is higher than the price preference indicated by the patient. When certain provider information and patient information do not match, the patient may be warned of the discrepancy and given the option to cancel the match request. For example, a provider with a price outside of the requested price, or a provider that will arrive later than requested.

In another embodiment, certain types of provider information must be compatible with the patient information. In this embodiment, if particular pieces of provider information for a provider are not compatible with patient information, the provider will not be returned as a match. For example, in one embodiment, a provider must provide the services specified in the match request. If the provider does not provide the services specified in the match request, the provider will not be returned as a match.

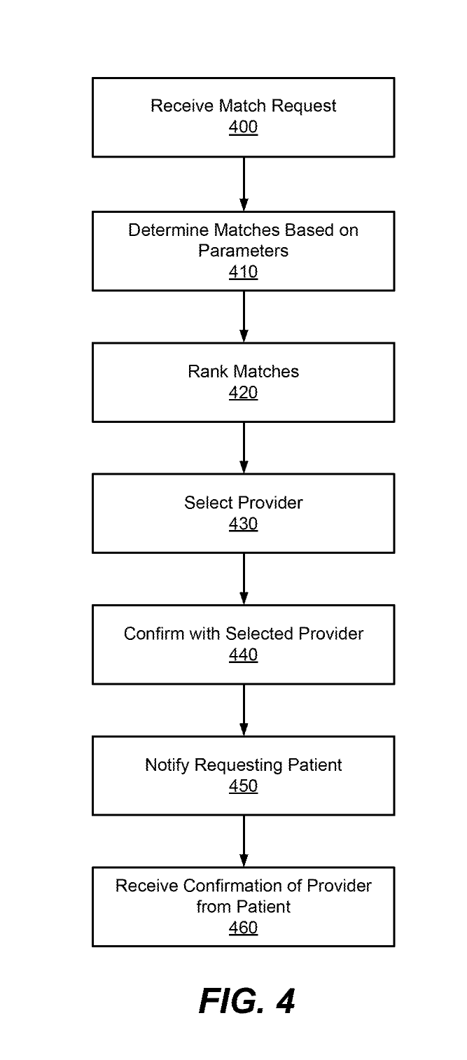

In one embodiment, matching providers are ranked by the ranking module 350 based on a match strength of each matching provider. Match strength may be determined based on which provider information is compatible with patient information and a degree to which the information is compatible or incompatible. For example, the matching module 340 may return a list of providers that can meet the patient's medical needs, and the ranking module 350 may determine which of the providers best match the patient's preferences. The ranking module 350 may select and return the highest ranked matching provider, or may return a ranked list of all matching providers. In one embodiment, the device interface module 330 sends a confirmation request to a matching provider. A confirmation request may include patient information, and it may require that the provider confirm the match prior to notifying the requesting patient of the match. An example matching process is discussed in more detail with respect to FIG. 4 below.

V. Example Matching Process

FIG. 4 is a flowchart of the steps for an example process for matching a patient with a provider, according to one embodiment. The device interface module 330 receives 400 a match request from a patient device 110. In one embodiment, the match request specifies a timeframe for an appointment. In another embodiment, the patient matching system has access to patient schedule information and uses that information to determine an appropriate timeframe for an appointment. In various embodiments, the appointment timeframe is a point in time or a time range at which an appointment can begin.

The matching module 340 determines 410 matches based on patient information and provider information. Matches may be determined using a variety of methods, including filtering providers based on provider information, excluding providers whose information is not compatible with patient information, selecting providers that do conform to required patient information, such as providing the requested medical care, and so forth.

In one embodiment, the matching module 340 determines which possible providers are available for an appointment during the appointment timeframe. The matching module 340 may determine the patient location and the provider location and determine whether the provider can be present at the patient's location during the appointment timeframe. For example, the matching module 340 may determine a travel time between the provider location and the patient location using known techniques, and determine whether the provider has ample travel time to travel to the patient location for the appointment. Determining travel time may include accessing provider schedule information to determine previously-scheduled appointments and other availability information. In one embodiment, provider availability is used to exclude unavailable providers as potential matches. In another embodiment, provider availability may be used to provide options for appointments at different times to users.

Responsive to determining matches, the ranking module 350 ranks 420 the determined matches. In one embodiment, the ranking module 350 selects 430 a provider based on the ranking. Alternatively, the ranking module 350 may provide a ranked list of providers to the patient device and receive a selection of a provider from the ranked list. The device interface module 330 may send a confirmation request to the selected provider to confirm 440 the match with the selected provider. If a selected provider does not confirm (either by not responding or by denying the confirmation request), the process returns to step 430 and the ranking module 350 may select another provider based on the ranking.

If the provider confirms, the device interface module 330 notifies 450 the requesting patient device 110 that a match has been determined. The patient may be presented with an option to confirm the matched provider. If the patient confirms the matched provider, the device interface module 330 receives 460 confirmation of the provider from the patient device 110. In one embodiment, the requesting patient may refuse the match, and the process returns to step 430 with the refused matching provider excluded from the list of matching providers. Following an appointment between a patient and a provider, the patient and the provider may be prompted to assign a rating to the appointment experience. For example, device interface module 330 may send a request for a rating to a patient device 110. The patient may assign a rating within a range (e.g., 1-5, 0-100, etc.) to the experience with the provider. In one embodiment, a patient may assign more than one rating corresponding to different aspects of the appointment experience (e.g., provider's punctuality, provider's quality of care, provider's adherence to price information, etc.). Provider rating data may be sent back to device interface module 330 and stored in provider data store 320. Provider rating data may be used along with other provider information to determine future matches.

Similarly, device interface module 330 may send a request for a rating to a provider device 120. The provider may assign a rating to the experience with the patient. In one embodiment, the provider may assign more than one rating corresponding to different aspects of the appointment experience. Patient rating data may be sent back to device interface module 330 and stored in patient data store 310. Patient rating data may be used along with other provider information to determine future matches. For example, providers with higher patient ratings may be ranked higher that other providers.

VI. Additional Considerations

The foregoing description of the embodiments of the invention has been presented for the purpose of illustration; it is not intended to be exhaustive or to limit the invention to the precise forms disclosed. Persons skilled in the relevant art can appreciate that many modifications and variations are possible in light of the above disclosure.

Some portions of this description describe the embodiments of the invention in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Embodiments of the invention may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Embodiments of the invention may also relate to a product that is produced by a computing process described herein. Such a product may comprise information resulting from a computing process, where the information is stored on a non-transitory, tangible computer readable storage medium and may include any embodiment of a computer program product or other data combination described herein.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based hereon. Accordingly, the disclosure of the embodiments of the invention is intended to be illustrative, but not limiting, of the scope of the invention, which is set forth in the following claims.

1. A method comprising:
receiving, at a patient matching system, a matching request to identify a provider for a patient associated with a patient device, the request indicating a medical service requested for the patient;
accessing patient information corresponding to the patient;
accessing provider information corresponding to each of the candidate providers of a plurality of candidate providers, the provider information comprising medical services offered by the provider; and
determining a matching provider based on the patient information and the provider information, the determining comprising:
determining whether the medical service requested by the patient is offered by the provider;
determining a location of the patient;
determining a coverage area of each of the candidate providers;
for each of the candidate providers, determining whether the location of the patient is in the coverage area of the candidate provider; and
responsive to determining that the location of the patient is not in the coverage area of the provider, removing the provider from the plurality candidate providers.

2. The method of claim 1, further comprising sending, to the patient device, a match confirmation identifying the matching provider.

3. The method of claim 1, wherein the patient information comprises patient schedule information indicating when the patient is available for services and the provider information for each candidate provider comprises provider schedule information indicating when the candidate provider is available for services.

4. The method of claim 3, wherein determining the matching provider comprises analyzing the patient schedule information and the provider schedule information to determine which of the plurality of candidate providers is available for services simultaneously with the patient.

5. The method of claim 1, wherein the match confirmation is sent to the patient device responsive to receiving a provider confirmation from the provider that indicates acceptance of the match.

6. The method of claim 1, further comprising identifying one or more additional matching providers.

7. The method of claim 6, further comprising determining, for the matching provider and each additional matching provider, a match metric indicating a strength of the match with the patient, wherein the matching provider and the additional matching providers are ranked according to determined match metrics.

8. A computer program product stored on a non-transitory computer readable medium and including instructions that when loaded into memory cause a computer processor to carry out the steps of:
receiving, at a patient matching system, a matching request to identify a provider for a patient associated with a patient device, the request indicating a medical service requested for the patient;
accessing patient information corresponding to the patient;
accessing provider information corresponding to each of the candidate providers of a plurality of candidate providers, the provider information comprising medical services offered by the provider; and
determining a matching provider based on the patient information and the provider information, the determining comprising:
determining whether the medical service requested by the patient is offered by the provider;
determining a location of the patient;
determining a coverage area of each of the candidate providers;
for each of the candidate providers, determining whether the location of the patient is in the coverage area of the candidate provider; and
responsive to determining that the location of the patient is not in the coverage area of the provider, removing the provider from the plurality candidate providers.

9. The computer program product of claim 8, further comprising sending, to the patient device, a match confirmation identifying the matching provider.

10. The computer program product of claim 8, wherein the patient information comprises patient schedule information indicating when the patient is available for services and the provider information for each candidate provider comprises provider schedule information indicating when the candidate provider is available for services.

11. The computer program product of claim 10, wherein determining the matching provider comprises analyzing the patient schedule information and the provider schedule information to determine which of the plurality of candidate providers is available for services simultaneously with the patient.

12. The computer program product of claim 8, wherein the match confirmation is sent to the patient device responsive to receiving a provider confirmation from the provider that indicates acceptance of the match.

13. The computer program product of claim 8, further comprising identifying one or more additional matching providers.

14. The computer program product of claim 13, further comprising determining, for the matching provider and each additional matching provider, a match metric indicating a strength of the match with the patient, wherein the matching provider and the additional matching providers are ranked according to determined match metrics.

15. A computing device comprising:
a processor configured to execute modules; and
a memory storing the modules, the modules comprising:
a device interface module configured to receive, at a patient matching system, a matching request to identify a provider for a patient associated with a patient device, the request indicating a medical service requested for the patient; and
a matching module configured to:
access patient information corresponding to the patient;
access provider information corresponding to each of the candidate providers of a plurality of candidate providers, the provider information comprising medical services offered by the provider; and
determine a matching provider based on the patient information and the provider information, the determining comprising:
determining whether the medical service requested by the patient is offered by the provider;
determining a location of the patient;
determining a coverage area of each of the candidate providers;
for each of the candidate providers, determining whether the location of the patient is in the coverage area of the candidate provider; and
responsive to determining that the location of the patient is not in the coverage area of the provider, removing the provider from the plurality candidate providers.

16. The computing device of claim 15, wherein the device interface module is further configured to send, to the patient device, a match confirmation identifying the matching provider.

17. The computing device of claim 15, wherein the patient information comprises patient schedule information indicating when the patient is available for services and the provider information for each candidate provider comprises provider schedule information indicating when the candidate provider is available for services.

18. The computing device of claim 15, wherein the match confirmation is sent to the patient device responsive to receiving a provider confirmation from the provider that indicates acceptance of the match.

19. The computing device of claim 15, wherein the matching module is further configured to identify one or more additional matching providers.

20. The computing device of claim 19, wherein the matching module is further configured to determine, for the matching provider and each additional matching provider, a match metric indicating a strength of the match with the patient, wherein the matching provider and the additional matching providers are ranked according to determined match metrics.
